(19) United States
(12) Patent Application Publication
(10) Pub. No.: US 2023/0342687 A1
(43) Pub. Date: Oct. 26, 2023

(54) SYSTEMS AND METHODS FOR UTILIZING VEHICLE DATA TO IDENTIFY EVENTS ASSOCIATED WITH SCHEDULED JOBS

(71) Applicant: VERIZON PATENT AND LICENSING INC., Basking Ridge, NJ (US)

(72) Inventors: Giovanni PINI, Florence (IT); Filippo VALENTE, Sesto Fiorentino (IT); Francesco DE FELICE, Firenze (IT); David DI LORENZO, Florence (IT)

(21) Appl. No.: 17/659,912

(22) Filed: Apr. 20, 2022

(51) Int. Cl. G06Q 10/06

(52) U.S. Cl. CPC G06Q 10/06312

(57) ABSTRACT

In some implementations, a device may receive vehicle data associated with a plurality of vehicles and schedule data associated with a plurality of jobs. The device may determine a set of scores for each job, of the plurality of jobs based on the vehicle data and the schedule data, wherein the set of scores for each job, of the plurality of jobs, indicates a set of likelihoods that each event is associated with each job. The device may determine a set of assignments of events to jobs based on the set of scores for each job. The device may determine a calculated job time period for each job based on the set of assignments. The device may modify, based on the calculated job time periods, the schedule data generate modified schedule data. The device may generate new schedule data for a new job based on the modified schedule data.

### BACKGROUND

A fleet management system may include software that enables a user (e.g., a fleet manager) to accomplish a variety of tasks related to the management of a company's fleet of vehicles. For example, a fleet management system may enable a user to monitor a status of a vehicle, determine a current location of a vehicle, schedule maintenance for a vehicle, and/or the like.

### BRIEF DESCRIPTION OF THE DRAWINGS

FIGS. 1A-1G are diagrams of an example associated with utilizing vehicle data to identify events associated with scheduled jobs.

FIG. 2 is a flowchart of an example process relating to utilizing vehicle data to identify events associated with scheduled jobs.

FIG. 3 is a diagram of an example environment in which systems and/or methods described herein may be implemented.

FIG. 4 is a diagram of example components of one or more devices of FIG. 3.

FIG. 5 is a flowchart of an example process relating to utilizing vehicle data to identify events associated with scheduled jobs.

### DETAILED DESCRIPTION OF EXAMPLE EMBODIMENTS

The following detailed description of example implementations refers to the accompanying drawings. The same reference numbers in different drawings may identify the same or similar elements.

An entity (e.g., a business, a company, or a network service provider, among other examples) may utilize vehicles to travel to a location of a customer and to deliver goods or to provide a service (e.g., a repair service, a delivery service, or an installation service, among other examples). A fleet manager may be an employee of the entity that is responsible for managing and/or supervising the entity's vehicles and/or the employees utilizing the vehicles to deliver the goods or provide the service.

In some cases, the fleet manager may utilize a fleet management system to manage and/or supervise the entity's vehicles and/or the employees utilizing the vehicles to deliver the goods or provide the service. In some cases, the fleet management system may enable the fleet manager to monitor a status of the vehicles utilizing vehicle data obtained from each vehicle. For example, each vehicle may include a device (e.g., a vehicle tracking unit (VTU)) and/or an application executing on a user device carried by an employee that continuously or periodically records telemetry data (e.g., location data indicating a location of the vehicle, speed data indicating a speed of the vehicle, acceleration data indicating an acceleration of the vehicle, and/or engine data indicating a status (e.g., on or off) of the vehicle's engine, among other examples) obtained by one or more sensors of the vehicle.

The VTU and/or the application may provide the recorded telemetry data to the fleet management system (e.g., continuously, periodically, and/or in response to a request received from the fleet management system). The fleet management system may receive the telemetry data from the vehicles and may utilize the telemetry data to indicate a current position of the vehicles on a map, a current speed of the vehicles, a current rate of acceleration of the vehicles, a location to which each vehicle is traveling, and/or a direction each vehicle is traveling, among other examples.

In some cases, the fleet manager may utilize a scheduling and dispatching application that enables the fleet manager to define a job and to assign the job to an employee. For example, the fleet manager may define a job by inputting information about the job (e.g., information describing a job to be performed, a location at which the job is to be performed, a vehicle to be utilized to perform the job, and/or an expected amount of time required for the employee to perform the job) and may assign the defined task to one or more employees.

In some cases, it may be beneficial to determine an actual amount of time that an employee took to complete an assigned job (e.g., rather than the expected amount of time indicated in the scheduling data). For example, determining the actual amount of time may enable an entity to determine an accurate price to charge the customer for which the job was performed, optimize workloads more effectively for different jobs, and/or identify an efficiency or speed at which an employee is able to perform the job. However, information indicating the actual amount of time that an employee took to complete the job may not be available to the scheduling and dispatching application and/or the scheduling and dispatching application may not be configured to provide a comparison between the expected amount of time and the actual amount of time for the employee to complete a job.

In some cases, the fleet manager may review the recorded telemetry data to determine the actual amount of time for the employee to complete a job. For example, the fleet manager may determine a vehicle utilized by the employee to travel to a location at which the job was performed. The fleet manager may search the recorded telemetry data to determine a location that corresponds to, or is within the vicinity of, the location at which the job was performed. The fleet manager may determine an amount of time that the vehicle was stopped at the location and may determine that the actual time it took for the employee to complete the job corresponds to the amount of time that the vehicle was stopped at the location.

However, determining that the actual time it took for the employee to complete the job corresponds to the amount of time that the vehicle was stopped at the location may result in the actual amount of time being incorrectly determined. For example, the employee may be assigned multiple jobs for multiple customers that are in the vicinity of the location at which the vehicle was stopped, and the employee may walk (rather than utilize the vehicle) to the multiple jobs. Utilizing the amount of time that the vehicle was stopped at the location may not account for the employee performing the multiple jobs and/or may not enable the fleet manager to determine a portion of the time associated with each job.

As another example, the employee may not be able to find a parking space in the vicinity of the customer's location and may park the vehicle a considerable distance from the customer's location. In these cases, the fleet manager may not be able to identify a location that corresponds to, or is within the vicinity of, the customer's location based on the telemetry data.

As another example, before completing the job, the employee may have traveled from the customer's location. For example, the employee may travel to a warehouse to obtain a part needed to complete the job and may return to the customer's location upon obtaining the part from the warehouse. The fleet manager may not be able to determine based on the recorded telemetry data whether the actual time for completing the job includes an amount of time the vehicle was stopped at or near the customer's location prior to traveling to the warehouse, the amount of time for the vehicle to travel to the warehouse and return to the customer's location, and/or the amount of time the vehicle was stopped at or near the customer's location after traveling from the warehouse.

Some implementations described herein enable a fleet management system to determine an actual amount of time required to complete a job based on recorded telemetry data and scheduling data. In some implementations, the fleet management system may obtain telemetry data associated with a group of vehicles. The fleet management system may identify vehicle events based on the telemetry data. The vehicle events may include one or more non-moving event and/or one or more moving events. A non-moving event may include a stop event (e.g., a vehicle being stopped at a location with the engine turned off) or an idling event (e.g., a vehicle stopped at a location with the engine running). A moving event may correspond to a vehicle traveling between two non-moving events (e.g., between two stop events, two idling events, a stop event and an idling event, or an idling event and a stop event).

The fleet management system may receive scheduling data indicating a plurality of jobs. For each job, the fleet management system may determine a cost for assigning each non-moving event to the job. The cost may be determined based on a distance between a location of the non-moving event and a location of the job, whether the non-moving event is a stop event or an idling event, and/or the absolute difference between the expected duration of the job indicated by the scheduling data and a duration of the non-moving event. In some implementations, the fleet management may assign a fixed cost to each job that is not assigned a non-moving event.

The fleet management system may generate an assignment problem (e.g., the problem of assigning a number of elements of a set A (e.g., the plurality of non-moving events) to a number of elements of a set B (e.g., the plurality of jobs) while minimizing a sum of the costs associated with the assignments). The fleet management system may solve the assignment problem to determine an initial set of assignments that minimizes a sum of the costs associated with the set of assignments (e.g., an initial best cost).

In some implementations, for every non-moving event that is not split or joined (described below), the fleet management system may, based on a first set of rules, split the event into multiple events and solve the resulting assignment problem. Additionally, for every non-moving event that is not split or joined, the fleet management system may, based on a second set of rules, join the non-moving event with one or more non-moving events occurring next in time and solve the resulting assignment problem.

For every non-moving event that originated from splitting a non-moving event, the fleet management system may unsplit the non-moving event (e.g., join the non-moving events that were generated based on splitting the non-moving event) and solve the resulting assignment problem. For every non-moving event that originated from a joining one or more non-moving events, the fleet management system may unjoin the non-moving event (e.g., split the non-moving event into the non-moving events that were joined to generate the non-moving event) and solve the resulting assignment problem.

The fleet management system may determine a set of assignments associated with a lowest total cost based on solving the assignment problems associated with splitting the events, joining the events, unsplitting the events, and unjoining the events. The fleet management system may determine whether the determined lowest total cost is less than the initial total cost. The fleet management system may determine an actual amount of time to complete each job based on the initial set of assignments when the determined lowest total cost is not less than the initial total cost. The fleet management system may replace the initial set of assignments with the determined set of assignments and may perform another iteration of the process described above when the determined lowest cost is less than the initial total cost.

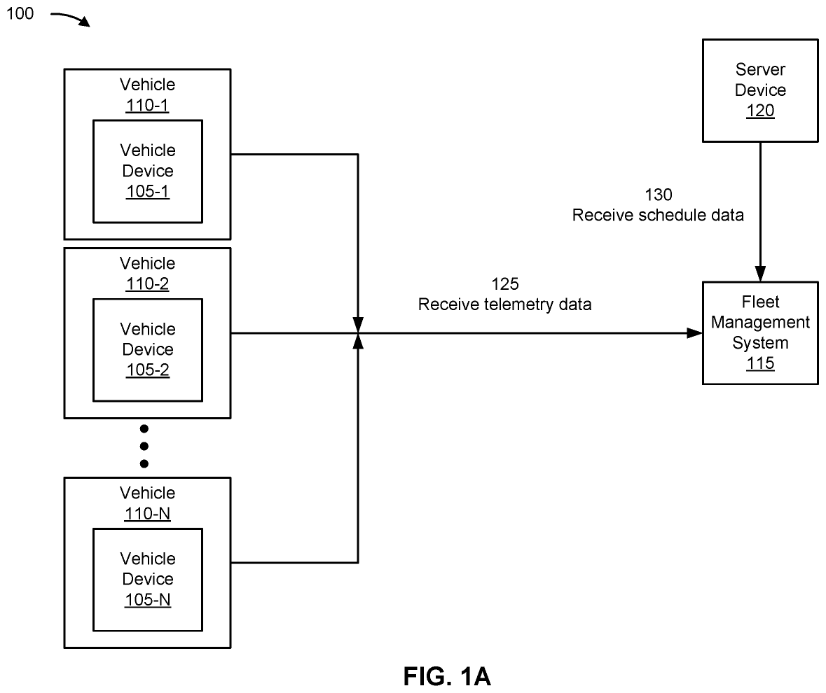

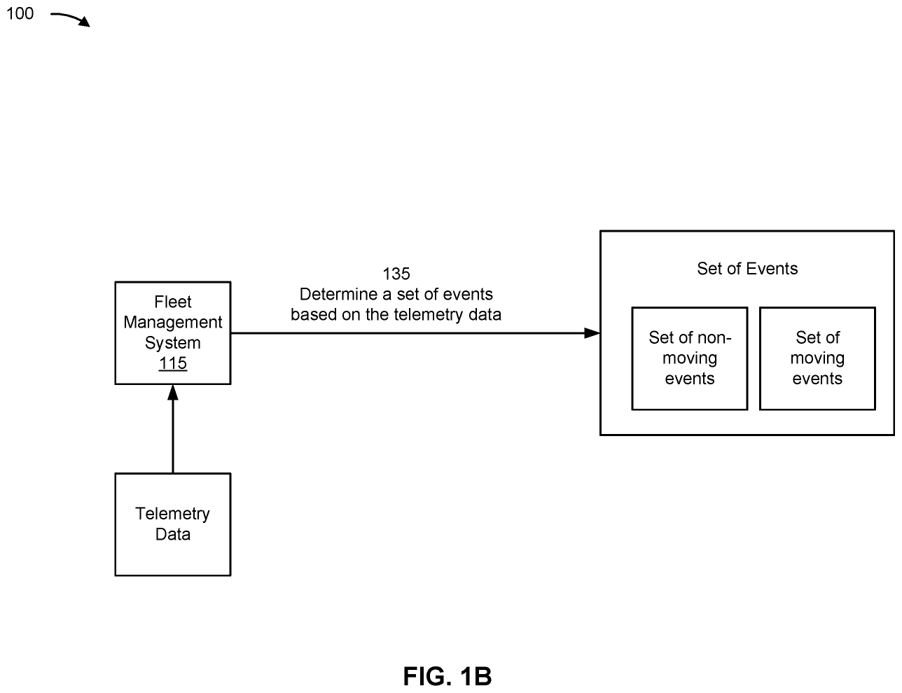

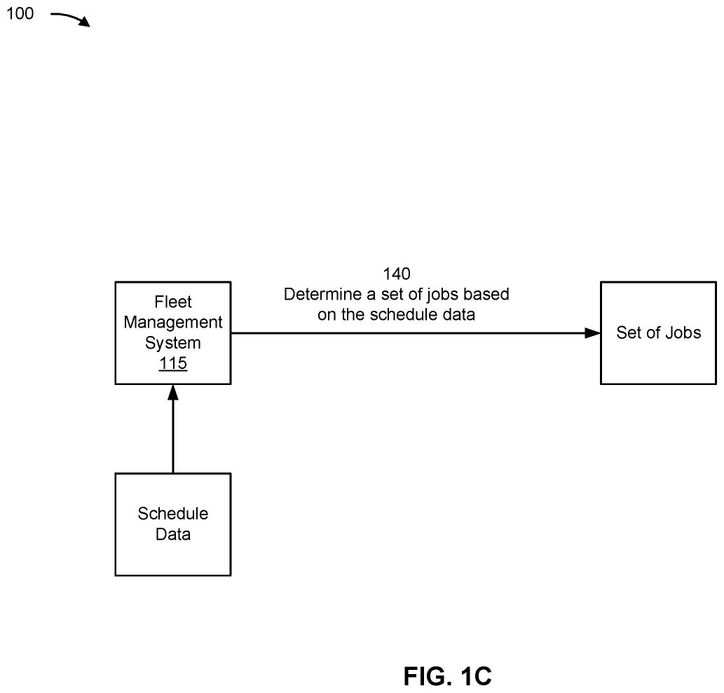

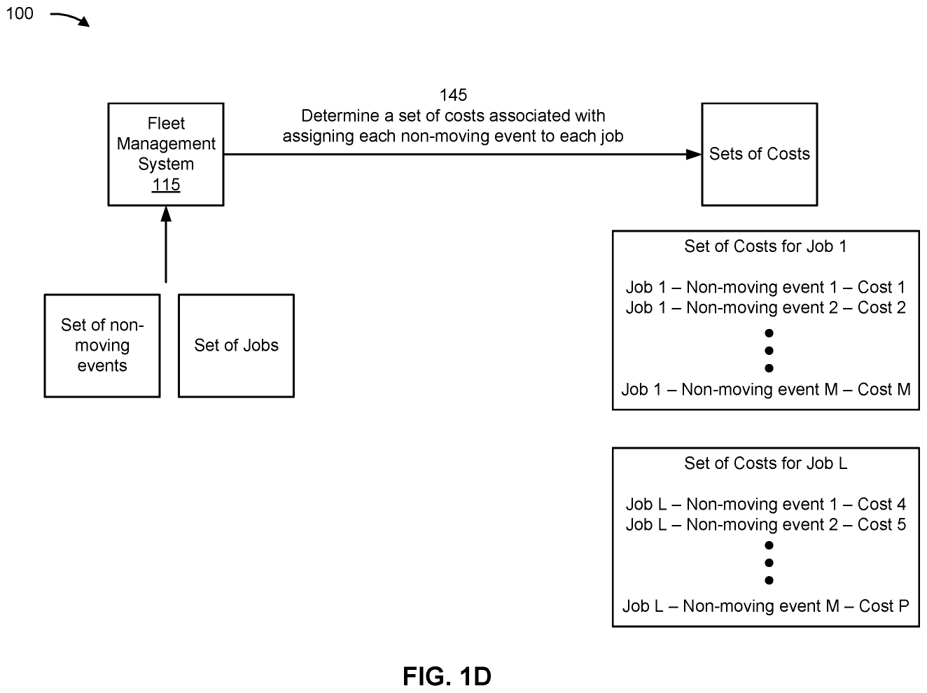

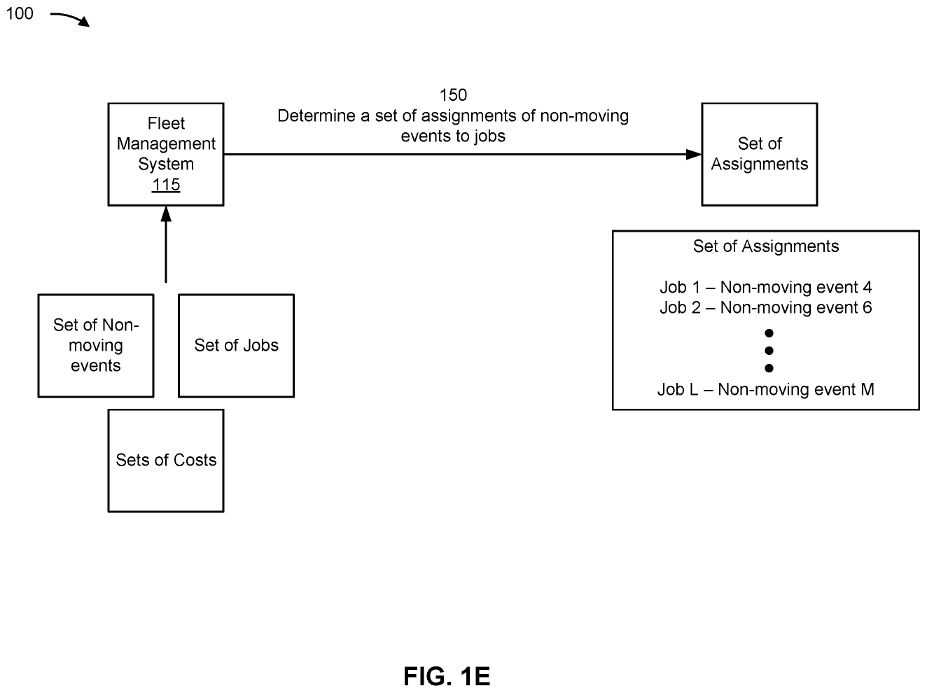

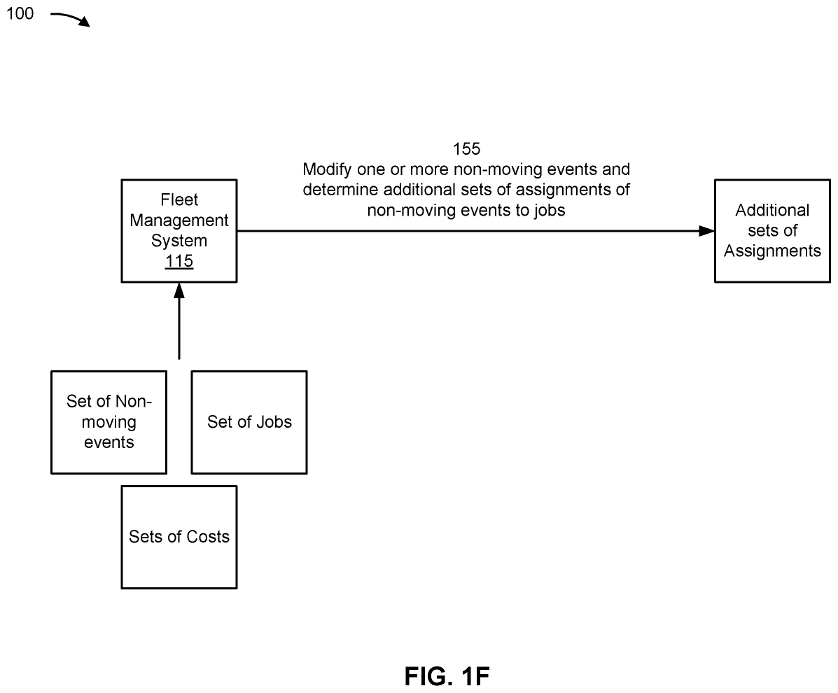

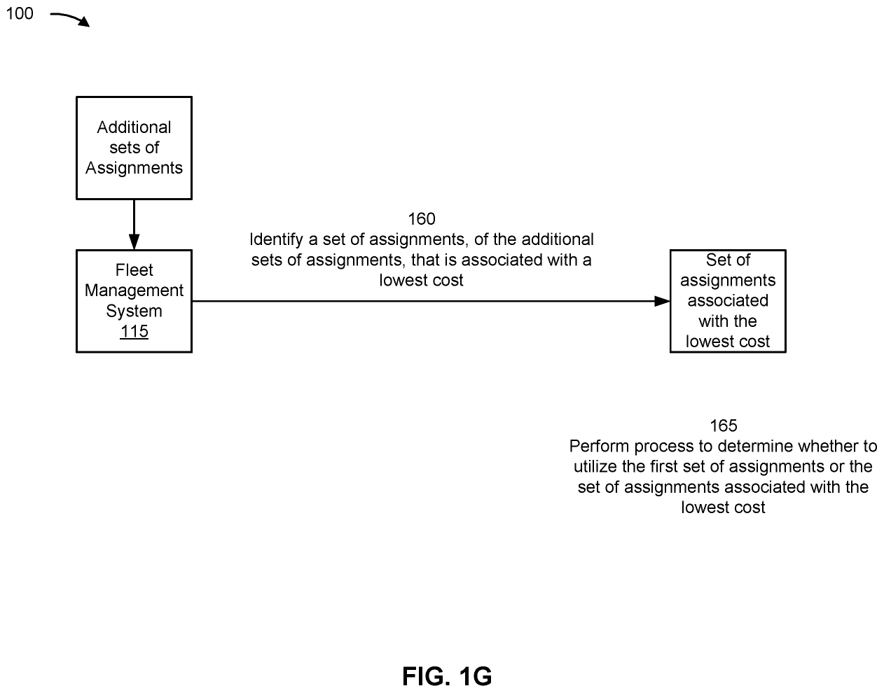

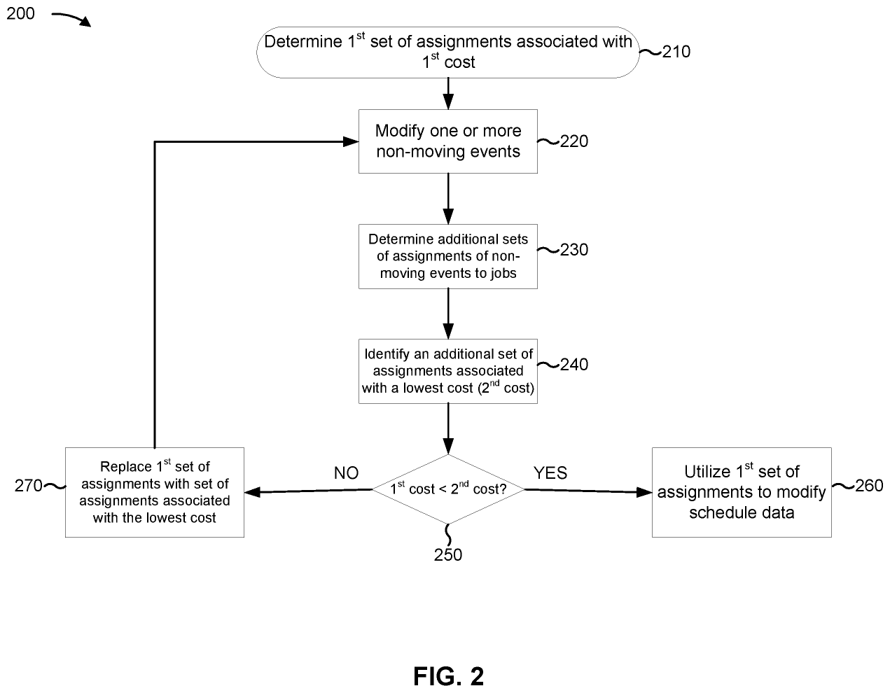

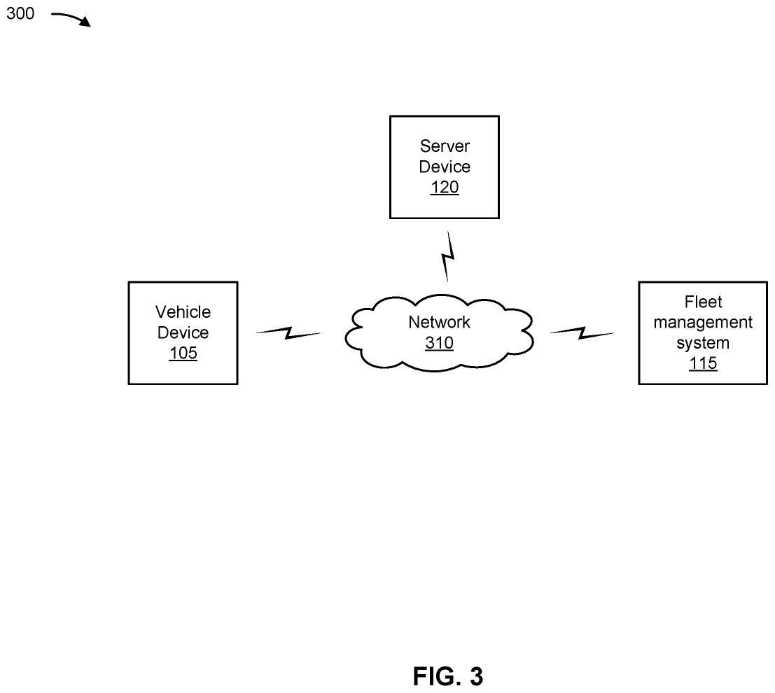

FIGS. 1A-1G are diagrams of an example 100 associated with utilizing vehicle data to identify events associated with scheduled jobs. As shown in FIGS. 1A-1G, example 100 includes a vehicle device 105 associated with a vehicle 110 (shown as vehicle 110-1 through 110-N), a fleet management system 115, and a server device 120. These devices are described in greater detail below with respect to FIGS. 2 and 3.

An entity (e.g., a business or a company) may utilize a group of vehicles 110 to deliver goods or to perform services (e.g., a repair service or an installation service) at a location of a customer (e.g., a home or a workplace of the customer). Each vehicle 110 may associated with a vehicle device 105. In some implementations, a vehicle device 105 may be included on a vehicle 110 with which it is associated. Additionally, or alternatively, the vehicle device 105 may be included in a user device associated with a driver of the vehicle.

The vehicle device 105 may record telemetry data obtained by one or more sensors associated with the vehicle 110. For example, the vehicle device 105 may continuously or periodically record telemetry data indicating a location of the vehicle 110, a speed of the vehicle, an acceleration (or deceleration) of the vehicle, and/or a status (e.g., on, off, running, not running, and/or the like) of an engine of the vehicle.

In some implementations, the telemetry data may include a time associated with each instance of recorded data. For example, the telemetry data may indicate a time a vehicle 110 was at a location, a time at which an engine of the vehicle 110 was turned on, a time at which the engine was turned off, and/or a time at which the vehicle 110 was traveling at a recorded speed, among other examples.

As shown in FIG. 1A, and by reference number 125, the fleet management system 115 may receive telemetry data associated with the plurality of vehicles 110. In some implementations, the fleet management system 115 may receive the telemetry data directly from a vehicle device 105. For example, one or more portions of the fleet management system 115 may be included in a multi-access edge computing (MEC) environment. In a MEC environment, computing may be enabled by a network architecture that provides computing capabilities to a connected device (e.g., vehicle devices 105) via computing platforms at or near an edge of a network (e.g., a wireless communication network). Accordingly, because a MEC environment may provide computing at or near the edge of the network, increased performance may be achieved over networks in which computing is performed topologically and/or physically further from a connected device. For example, the MEC environment may offer improved performance due to less traffic and/or congestion between the connected device and the computing node(s), less latency (due to closer proximity to the connected device), and/or increased flexibility (due to a greater amount of computing node(s)).

In some implementations, the fleet management system 115 may receive the telemetry data from another device. For example, the vehicle device 105 may provide the telemetry data to a server device associated with the fleet management system 115, and the fleet management system 115 may receive the telemetry data from the server device.

As shown by reference number 130, the fleet management system 115 may receive schedule data from a server device 120. In some implementations, the server device 120 may include a scheduling and dispatching system that provides the schedule data to the fleet management system 115. Additionally, or alternatively, the server device 120 may receive the schedule data from a scheduling and dispatching system included in another device (e.g., another server device). The server device 120 may provide the schedule data to the fleet management system 115 based on receiving the schedule data from the other device.

In some implementations, the schedule data is associated with a group of users associated with the vehicles 110 and/or the vehicle devices 105 from which the telemetry data is received. In some implementations, the group of users may include a single user. In some implementations, the group of users may include a group of related users. For example, the group of users may include a group of users employed by the same company, a group of users assigned to a particular department within the company, and/or users operating a particular type of vehicle 110 (e.g., a truck, a van, or a car), among other examples.

In some implementations, the schedule data may indicate a plurality of jobs. A job may be a service (e.g., a repair service, an installation service, or a delivery service) that is provided to a customer at a particular location. For each job, the schedule data may include information indicating one or more characteristics associated with the job. For example, for a particular job, the schedule data may indicate a user to which the particular job is assigned, a vehicle 110 associated with the user, a vehicle device 105 associated with the user, a time and/or a location at which the particular job is scheduled to be performed, and/or an expected duration of the job.

As shown in FIG. 1B, and by reference number 135, the fleet management system 115 may determine a set of vehicle events based on the telemetry data. In some implementations, the set of vehicle events may include a set of non-moving events. The fleet management system 115 may identify, based on the telemetry data, a location at which a vehicle 110 remained for at least a time period (e.g., 5 seconds, 10 seconds, or 15 seconds, among other examples). The fleet management system 115 may determine an occurrence of a non-moving event at the location based on the vehicle remaining at the location for at least the time period.

In some implementations, the fleet management system 115 may classify the non-moving event as a stop event or an idling event based on a status of an engine of the vehicle 110. The fleet management system 115 may determine, based on the telemetry data, whether the engine was running while the vehicle 110 was stopped at the location for the time period. The fleet management system 115 may classify the non-moving event as an idling event when the engine was running while the vehicle 110 was stopped at the location for the time period. The fleet management system 115 may classify the non-moving event as a stop event when the engine was not running while the vehicle 110 was stopped at the location for the time period.

In some implementations, the set of vehicle events may include a set of moving events. The fleet management system 115 may determine, based on the telemetry data, an occurrence of a first non-moving event followed, in time, by a next or second non-moving event. The fleet management system 115 may identify a moving event as corresponding to the vehicle 110 traveling from the first non-moving event to second non-moving event.

As shown in FIG. 1C, and by reference number 140, the fleet management system 115 may determine a set of jobs based on the schedule data. For example, the schedule data may include a list of jobs scheduled for a time period (e.g., a day, a week, or a month). The fleet management system 115 may determine the set of jobs based on the list of jobs included in the schedule data.

In some implementations, for each job included in the set of jobs, the fleet management system 115 may determine (e.g., based on the schedule data) one or more characteristics associated with the job. For example, the fleet management system 115 may determine a location at which the job is to be performed, an expected duration of the job, a scheduled starting time for the job, a user to which the job is assigned, and/or a vehicle 110 associated with the job and/or the user, among other examples.

As shown in FIG. 1D, and by reference number 145, for each job, the fleet management system 115 may determine a set of costs associated with assigning each non-moving event to the job. As an example, the set of non-moving events may include a first non-moving event and a second non-moving event. The set of costs may include a first cost associated with assigning the first non-moving event to the job and a second cost assigning the second non-moving event to the job.

In some implementations, the fleet management system 115 may determine the cost for assigning a non-moving event to a job based on a distance between a location of the non-moving event and a location of the job, whether the non-moving event is a stop event or an idling event, and/or an absolute difference between a duration of the non-moving event and an expected duration of the job indicated by the schedule data. For example, the cost (C) for assigning a non-moving event (e) to a job (j) may be determine based on the formula:

Cₑⱼ=(d×c_{d})+(t×cₜ)+C_{idle},

where d is the distance between a location of the non-moving event and a location of the job, c_{d} is a constant value (e.g., 0.5, 1.0, or 1.5, among other examples) that indicates a cost associated with the distance between a location of the non-moving event and a location of the job, t is the absolute difference between a duration of the non-moving event and an expected duration of the job indicated by the schedule data, cₜ is a constant value (e.g., 0.01, 0.015, or 0.02, among other examples) that indicates a cost associated with the absolute difference between a duration of the non-moving event and an expected duration of the job indicated by the schedule data, and C_{idle} is a constant value (e.g., 0.5, 1.0, or 1.5, among other examples) that indicates a cost associated with an idling event being less likely to be associated with a job relative to a stop event, where c_{idle} is equal to zero when the non-moving event is a stop event.

In some implementations, the cost determined for assigning a non-moving event to a job may indicate an unlikelihood that the non-moving event is associated with the job. For example, based on the formula described above, the cost associated with assigning a non-moving event to a job may equal zero when a location of the non-moving event is the same as a location of a job (e.g., d=0), a duration of the non-moving event is equal to an expected duration of the job indicated by the schedule data (e.g., t=0), and the non-moving event is a stop event (e.g., c_{idle}=0).

In some implementations, a job may not be associated with any of the non-moving events (e.g., the job was cancelled). To prevent an unrelated non-moving event from being assigned to the job, the fleet management system 115 may assign a fixed cost (e.g., 0.5, 1.0, or 2.0, among other examples) to each job to which a non-moving event is not assigned.

As shown in FIG. 1E, and by reference number 150, the fleet management system 115 may determine a set of assignments of non-moving events to jobs. In some implementations, the fleet management system 115 may determine a set of assignments (A) that minimizes the sum of Cₑⱼ for all assignments in the set of assignment plus the fixed cost assigned to every job for which a non-moving event is not assigned. Stated mathematically, the fleet management system 115 may minimize the value:

c=(Σ_{(e,j)∈A}C_ej)+c_unassigned*|j:!∃e:(e,j)∈A|

where c_unassigned is the fixed cost assigned to each job for which a non-moving event is not assigned.

In some implementations, the fleet management system 115 may determine the set of assignments based on solving an assignment problem. An assignment problem may correspond to the problem of assigning a number of elements of a set (e.g., the set of non-moving events) to a number of elements of another set (e.g., the set of jobs) while minimizing the cost of assigning the elements of the set to the element of the other set. In some implementations, the fleet management system 115 may solve the assignment problem based on the Hungarian algorithm or by linear programming, among other examples. The set of assignments corresponding to the solution of the assignment problem may be referred to as a first set of assignments.

As shown in FIG. 1F, and by reference number 155, the fleet management system 115 may modify one or more non-moving events included in the set of non-moving events and may determine one or more additional sets of assignments of non-moving events to jobs. In some implementations, the fleet management system 115 may modify one or more of the non-moving events based on performing a first procedure and/or a second procedure.

In some implementations, the first procedure may be associated with splitting a non-moving event (e.g., a parent event) into two or more non-moving events (e.g., two or more child events) and replacing the parent event with the two or more child events in the set of non-moving events. As described in greater detail below, by splitting a non-moving event, the fleet management system 115 may account for instances in which multiple jobs were performed while a vehicle 110 was parked at a single location (e.g., instances in which a single non-moving event should be assigned to multiple jobs).

In some implementations, the two or more child events may be associated with a same location as the location of the occurrence of the parent event. In some implementations, the two or more child events may comprise the same type of non-moving event (e.g., a stop event or an idling event) as the parent event.

In some implementations, a duration of a child event may be less than a duration of the parent event. In some implementations, the sum of the durations of the two or more child events may be equal to the duration of the parent event. For example, the fleet management system 115 may assign a portion of the duration of the parent event to each of the two or more child events. The portion of the duration of the parent event assigned to a child event may be the same as, or different from, the portion of the duration of the parent event assigned to another child event.

In some implementations, the second procedure may be associated with joining two or more non-moving events into a single event. As described in greater detail below, by joining two or more non-moving events into a single event, the fleet management system 115 may account instances in which a user started a job, left the location of the job prior to completing the job (e.g., to travel to a warehouse to obtain a part necessary to complete the job), and subsequently returned to complete the job.

In some implementations, the duration of the single event may be equal to a sum of the duration of the two or more non-moving events that were joined to generate the single event. For example, the duration of the single event may be a total amount of time from a start of a duration of a first non-moving event (e.g., a non-moving event of the two or more non-moving events that occurred first relative to the other non-moving events) to an end of a duration of a last non-moving event (e.g., a non-moving event of the two or more non-moving events that occurred after all of the other non-moving events).

In some implementations, the fleet management system 115 may classify the single event based on a classification associated with one of the two or more non-moving events that were joined to create the single event. For example, the fleet management system 115 may classify the single event based on a classification of the first non-moving event and/or the last non-moving event. In some implementations, the fleet management system 115 may classify the single event as an idling event when at least one of the first non-moving event or the second non-moving event is an idling event.

In some implementations, the two or more non-moving events may occur at different locations. The fleet management system 115 may determine a cost associated with assigning the single event to a job based on a distance of one or more of the locations of the two or more non-moving events from the location of the job. In some implementations, the fleet management system 115 may determine the cost associated with assigning the single event to the job based on a distance between the first non-moving event and the location of the job and a distance between the location of the last non-moving event and the location of the job. For example, the fleet management system 115 may determine the cost associated with assigning the single event to a job based on the following formula:

Cₑⱼ=(d₁×c_{d})+(d₂×c_{d})+(t×cₜ)+c_{idle},
where d₁ is the distance between the first non-moving event and the location of the job and d₂ is the distance between the location of the last non-moving event and the location of the job.

In some implementations, for every non-moving event that is not a result of splitting a non-moving event or joining two or more non-moving events, the fleet management system 115 may utilize the first procedure to split the non-moving event into two or more child events. The fleet management system 115 may replace the non-moving event with the two or more child events in the set of non-moving events. The fleet management system 115 may determine a second set of assignments based on solving an assignment problem associated with assigning non-moving events included in the set of non-moving events to jobs included in the set of jobs.

In some implementations, for every non-moving event that is not a result of splitting a non-moving event or joining two or more non-moving events, the fleet management system 115 may utilize the second procedure to join two or more non-moving events into a single event. The fleet management system 115 may replace the two or more non-moving events with the single event in the set of non-moving events. The fleet management system 115 may determine a third set of assignments based on solving an assignment problem associated with assigning non-moving events included in the set of non-moving events to jobs included in the set of jobs.

In some implementations, for every set of two or more child events that was generated based on splitting a parent event, the fleet management system 115 may join the set of two or more child events to generate the parent event and may replace the set of two or more child events with the parent event in the set of non-moving events. The fleet management system 115 may determine a fourth set of assignments based on solving an assignment problem associated with assigning non-moving events included in the set of non-moving events to jobs included in the set of jobs.

In some implementations, for every single event that was generated by joining two or more non-moving events, the fleet management system 115 may split the single event back into the two or more non-moving events. The fleet management system 115 may replace the single event with the two or more non-moving events in the set of non-moving events. The fleet management system 115 may determine a fifth set of assignments based on solving an assignment problem associated with assigning non-moving events included in the set of non-moving events to jobs included in the set of jobs.

As shown in FIG. 1G, and by reference number 160, the fleet management system 115 may identify a set of assignments, of the additional sets of assignments, that is associated with a lowest total cost relative to the other sets of assignments included in the additional sets of assignment. For example, the fleet management system 115 may determine that the third set of assignments is associated with a lowest cost relative to a cost associated with the second set of assignments, a cost associated with the fourth set of assignments, and a cost associated with the fifth set of assignments.

As shown by reference number 165, the fleet management system 115 may perform a process to determine whether to utilize the first set of assignments or the set of assignments associated with the lowest cost based on a comparison of the cost associated with the first set of assignments and the cost associated with the set of assignments associated with the lowest cost, as described in greater detail below with respect to FIG. 2.

As indicated above, FIGS. 1A-1G are provided as an example. Other examples may differ from what is described with regard to FIGS. 1A-1G. The number and arrangement of devices shown in FIGS. 1A-1G are provided as an example. In practice, there may be additional devices, fewer devices, different devices, or differently arranged devices than those shown in FIGS. 1A-1G. Furthermore, two or more devices shown in FIGS. 1A-1G may be implemented within a single device, or a single device shown in FIGS. 1A-1G may be implemented as multiple, distributed devices. Additionally, or alternatively, a set of devices (e.g., one or more devices) shown in FIGS. 1A-1G may perform one or more functions described as being performed by another set of devices shown in FIGS. 1A-1G.

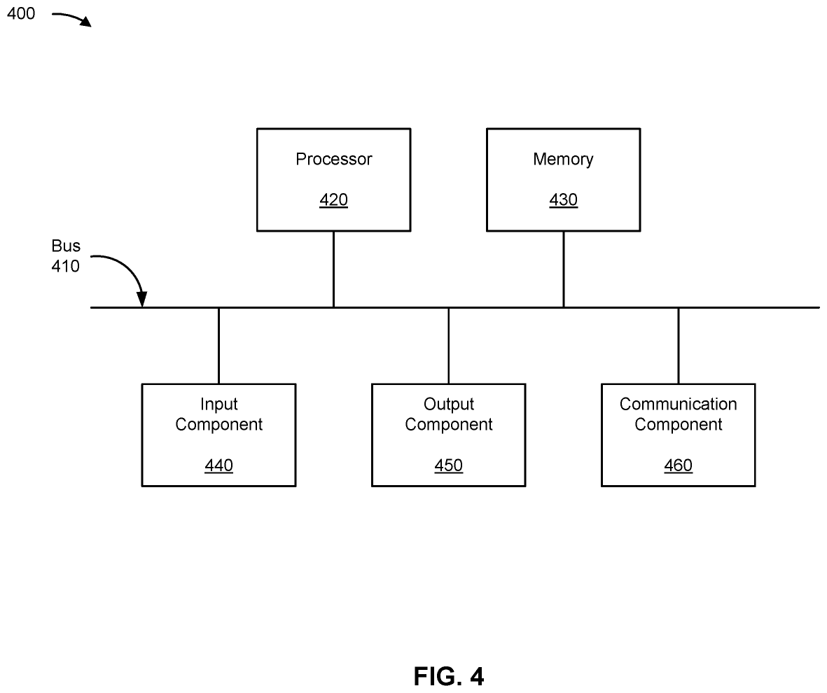

FIG. 2 is a flowchart of an example process 200 associated with determining whether to utilize the first set of assignments or the set of assignments associated with the lowest cost. In some implementations, one or more process blocks of FIG. 2 may be performed by a device (e.g., fleet management system 115). In some implementations, one or more process blocks of FIG. 2 may be performed by another device or a group of devices separate from or including the device, such as a vehicle device (e.g., vehicle device 105), and/or a server device (e.g., server device 120). Additionally, or alternatively, one or more process blocks of FIG. 2 may be performed by one or more components of device 400, such as processor 420, memory 430, input component 440, output component 450, and/or communication component 460, described below with respect to FIG. 4.

As shown in FIG. 2, process 200 may include determining the first set of assignments associated with a first cost (block 210). In some implementations, the fleet management system 115 may determine the first set of assignments and a first cost associated with the first set of assignments in a manner similar to that described above with respect to FIGS. 1A-1E.

As further shown in FIG. 2, process 200 may include determining additional sets of assignments of non-moving events to jobs based on modifying the one or more non-moving events (block 220). In some implementations, the fleet management system 115 may determine the additional sets of assignments of non-moving events to jobs in a manner similar to that described above with respect to FIG. 1F.

As further shown in FIG. 2, process 200 may include modifying one or more non-moving events (block 230). In some implementations, the fleet management system 115 may modify one or more non-moving events in a manner similar to that described above with respect to FIG. 1F.

As further shown in FIG. 2, process 200 may include identifying a set of assignments (e.g., a second set of assignments), of the additional sets of assignments, that is associated with a lowest cost (e.g., a second cost) relative to the costs associated with the other sets of assignments included in the additional sets of assignments. In some implementations, the fleet management system 115 may identify the second set of assignments in a manner similar to that described above with respect to FIG. 1G.

As further shown in FIG. 2, process 200 may include determining whether the first cost is less than the second cost (block 250). For example, the fleet management system 115 may compare the first cost and the second cost and may determine whether the first cost is less than the second cost based on the comparison.

In some implementations, the fleet management system 115 may determine that the cost associated with the first set of assignments is less than the cost associated with the set of assignments associated with the lowest cost (block 250, YES). In these implementations, as further shown in FIG. 2, process 200 may include utilizing the first set of assignments to modify schedule data (block 260).

In some implementations, the fleet management system 115 may modify the schedule data based on a duration of each non-moving event assigned to each job. The fleet management system 115 may determine that an actual amount of time required to perform the job corresponds to the duration of the non-moving event assigned to the job. In some implementations, the fleet management system 115 may modify the schedule data to include information identifying the duration of the non-moving event assigned to each based on determining that the actual amount of time required to perform the job corresponds to the duration of the non-moving event assigned to each job.

In some implementations, the fleet management system 115 may determine a difference between the duration of the non-moving event assigned to a job and an expected duration of the job indicated in the schedule data. The fleet management system 115 may provide information indicating the job, the expected duration of the job indicated in the schedule data, the duration of the non-moving event, and/or the difference between the duration of the non-moving event assigned to the job and the expected duration of the job indicated in the schedule data. For example, the fleet management system 115 may cause the information indicating the job, the expected duration of the job indicated in the schedule data, the duration of the non-moving event, and/or the difference between the duration of the non-moving event assigned to the job and the expected duration of the job indicated in the schedule data to be provided to a user device associated with a particular user (e.g., a fleet manager).

In some implementations, the fleet management system 115 may determine that the first cost is not less than the second cost (block 250, NO). In these implementations, as shown in FIG. 2, process 200 may include replacing the first set of assignments with the second set of assignments based on the first cost not being less than the second cost (block 270).

As shown in FIG. 2, process 200 may include the fleet management system 115 performing another iteration of the process 200 based on the second set of assignments. In some implementations, the fleet management system 115 may continue to perform additional iterations of the process 200 until a lowest cost associated with the additional sets of assignments fails to be greater than the total cost associated with the set of assignments from which the additional sets of assignments were generated and/or until a preconfigured quantity of iterations (e.g., 5, 10, or 100, among other examples) have been performed.

Although FIG. 2 shows example blocks of process 200, in some implementations, process 200 may include additional blocks, fewer blocks, different blocks, or differently arranged blocks than those depicted in FIG. 2. Additionally, or alternatively, two or more of the blocks of process 200 may be performed in parallel.

FIG. 3 is a diagram of an example environment 300 in which systems and/or methods described herein may be implemented. As shown in FIG. 3, environment 300 may include a vehicle device 105, a fleet management system 115, a server device 120, and a network 310. Devices of environment 300 may interconnect via wired connections, wireless connections, or a combination of wired and wireless connections.

Vehicle device 105 includes one or more devices capable of receiving, generating, storing, processing, and/or providing information, such as information described herein. For example, vehicle device 105 may include a mobile phone (e.g., a smart phone, a radiotelephone, etc.), a laptop computer, a tablet computer, a handheld computer, a device included in vehicle 110 (e.g., an inertial measurement unit, a three-axis accelerometer, a global positioning system (GPS) device, an on-board diagnostics (OBD) device, an electronic control unit (ECU), a dash camera, a parking assist camera, a backup assist camera, a vehicle infotainment system, a vehicle navigation system, and/or the like) or a similar type of device. In some implementations, vehicle device 105 may receive obtain telemetry data obtained by one or more sensors of a vehicle 110 and may provide the telemetry data to the fleet management system 115.

The fleet management system 115 includes one or more devices capable of receiving, generating, storing, processing, providing, and/or routing information associated with utilizing vehicle data to identify events associated with scheduled jobs, as described elsewhere herein. The fleet management system 115 may include a communication device and/or a computing device. For example, the fleet management system 115 may include a server, such as an application server, a client server, a web server, a database server, a host server, a proxy server, a virtual server (e.g., executing on computing hardware), or a server in a cloud computing system. In some implementations, the fleet management system 115 includes computing hardware used in a cloud computing environment.

The server device 120 includes one or more devices capable of receiving, generating, storing, processing, providing, and/or routing information associated with schedule data, as described elsewhere herein. The server device 120 may include a communication device and/or a computing device. For example, the server device 120 may include a server, such as an application server, a client server, a web server, a database server, a host server, a proxy server, a virtual server (e.g., executing on computing hardware), or a server in a cloud computing system. In some implementations, the server device 120 includes computing hardware used in a cloud computing environment.

The network 310 includes one or more wired and/or wireless networks. For example, the network 310 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 310 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400, which may correspond to a vehicle device 105, a fleet management system 115, and/or a server device 120. In some implementations, the vehicle device 105, the fleet management system 115, and/or the server device 120 may include one or more devices 400 and/or one or more components of device 400. As shown in FIG. 4, device 400 may include a bus 410, a processor 420, a memory 430, an input component 440, an output component 450, and a communication component 460.

Bus 410 includes one or more components that enable wired and/or wireless communication among the components of device 400. Bus 410 may couple together two or more components of FIG. 4, such as via operative coupling, communicative coupling, electronic coupling, and/or electric coupling. Processor 420 includes a central processing unit, a graphics processing unit, a microprocessor, a controller, a microcontroller, a digital signal processor, a field-programmable gate array, an application-specific integrated circuit, and/or another type of processing component. Processor 420 is implemented in hardware, firmware, or a combination of hardware and software. In some implementations, processor 420 includes one or more processors capable of being programmed to perform one or more operations or processes described elsewhere herein.

Memory 430 includes volatile and/or nonvolatile memory. For example, memory 430 may include random access memory (RAM), read only memory (ROM), a hard disk drive, and/or another type of memory (e.g., a flash memory, a magnetic memory, and/or an optical memory). Memory 430 may include internal memory (e.g., RAM, ROM, or a hard disk drive) and/or removable memory (e.g., removable via a universal serial bus connection). Memory 430 may be a non-transitory computer-readable medium. Memory 430 stores information, instructions, and/or software (e.g., one or more software applications) related to the operation of device 400. In some implementations, memory 430 includes one or more memories that are coupled to one or more processors (e.g., processor 420), such as via bus 410.

Input component 440 enables device 400 to receive input, such as user input and/or sensed input. For example, input component 440 may include a touch screen, a keyboard, a keypad, a mouse, a button, a microphone, a switch, a sensor, a global positioning system sensor, an accelerometer, a gyroscope, and/or an actuator. Output component 450 enables device 400 to provide output, such as via a display, a speaker, and/or a light-emitting diode. Communication component 460 enables device 400 to communicate with other devices via a wired connection and/or a wireless connection. For example, communication component 460 may include a receiver, a transmitter, a transceiver, a modem, a network interface card, and/or an antenna.

Device 400 may perform one or more operations or processes described herein. For example, a non-transitory computer-readable medium (e.g., memory 430) may store a set of instructions (e.g., one or more instructions or code) for execution by processor 420. Processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry is used instead of or in combination with the instructions to perform one or more operations or processes described herein. Additionally, or alternatively, processor 420 may be configured to perform one or more operations or processes described herein. Thus, implementations described herein are not limited to any specific combination of hardware circuitry and software.

The number and arrangement of components shown in FIG. 4 are provided as an example. Device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

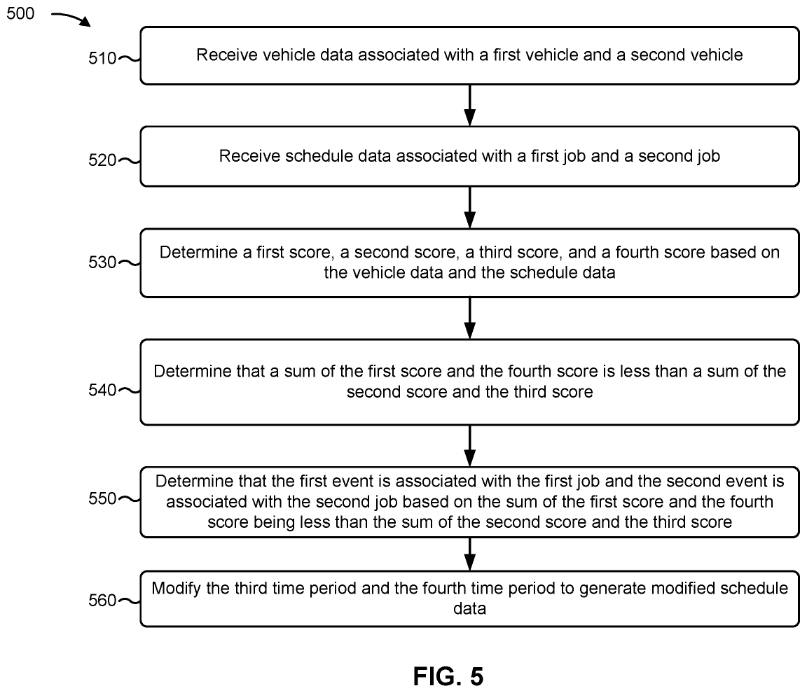

FIG. 5 is a flowchart of an example process 500 associated with systems and methods for utilizing vehicle data to identify events associated with scheduled jobs. In some implementations, one or more process blocks of FIG. 5 may be performed by a device (e.g., fleet management system 115). In some implementations, one or more process blocks of FIG. 5 may be performed by another device or a group of devices separate from or including the device, such as a vehicle device (e.g., vehicle device 105), and/or a server device (e.g., server device 120). Additionally, or alternatively, one or more process blocks of FIG. 5 may be performed by one or more components of device 400, such as processor 420, memory 430, input component 440, output component 450, and/or communication component 460.

As shown in FIG. 5, process 500 may include receiving vehicle data associated with a first vehicle and a second vehicle (block 510). For example, the device may receive vehicle data associated with a first vehicle and a second vehicle, wherein the vehicle data identifies a first event associated with the first vehicle and a second event associated with the second vehicle, a first location at which the first event occurred, a second location at which the second event occurred, a first time period corresponding to a duration of the first event, and a second time period corresponding to a duration of the second event, as described above.

As further shown in FIG. 5, process 500 may include receiving schedule data associated with a first job and a second job (block 520). For example, the device may receive schedule data associated with a first job and a second job, wherein the schedule data indicates a first job location associated with the first job, a second job location associated with the second job, a third time period corresponding to a predicted duration associated with the first job, and a fourth time period corresponding to a predicted duration associated with the second job, as described above.

As further shown in FIG. 5, process 500 may include determining a first score, a second score, a third score, and a fourth score based on the vehicle data and the schedule data (block 530). For example, the device may determine a first score, a second score, a third score, and a fourth score based on the vehicle data and the schedule data, wherein the first score indicates a first likelihood that the first event is associated with the first job, the second score indicates a second likelihood that the first event is associated with the second job, the third score indicates a third likelihood that the second event is associated with the first job, and the fourth score indicates a fourth likelihood that the second event is associated with the second job, as described above.

In some implementations, the device may determine that the first event corresponds to an idling event. The device may determine, based on the first event corresponding to the idling event, a first value based on a sum of the first time period and the third time period. The device may determine a second value based on a distance between the first location and the first job location. The device may determine the first score based on the first value and the second value.

In some implementations, the device may determine that the first event corresponds to a stop event. The device may set, based on the first event corresponding to the stop event, the first time period to a minimum time period. In some implementations, the minimum time period is equal to zero seconds. The device may determine, based on the first event corresponding to the stop event, a first value based on the first time period and a minimum time period. The device may determine a second value based on a distance between the first location and the first job location. The device may determine the first score based on the first value and the second value.

In some implementations, the device may generate a third event and a fourth event based on the first event. The third event may be associated with the first location and a portion of the first time period and the fourth event may be associated with the first location and a remaining portion of the first time period. The device may determine the first score based on the first location, the first job location, and the portion of the first time period. The device may determine a fifth score based on the first location, the first job location, and the remaining portion of the first time period. The fifth score may indicate a fifth likelihood that the fourth event is associated with the first job.

In some implementations, the vehicle data identifies a third event associated with the first vehicle, a third location at which the third event occurred, and a fifth time period corresponding to a duration of the third event. The device may determine the first score based on a difference between the first location and the first job location, a difference between the third location and the first job location, the first time period, and the fifth time period. The first score may indicate a fifth likelihood that the first job is associated with the first event and the third event.

In some implementations, the device determines the first score based on a sum of the first score, the fourth score, and a value associated with the third event not being associated with the first job or the second job.

As further shown in FIG. 5, process 500 may include determining that a sum of the first score and the fourth score is less than a sum of the second score and the third score (block 540). For example, the device may determine that a sum of the first score and the fourth score is less than a sum of the second score and the third score, as described above.

As further shown in FIG. 5, process 500 may include determining that the first event is associated with the first job and the second event is associated with the second job based on the sum of the first score and the fourth score being less than the sum of the second score and the third score (block 550). For example, the device may determine that the first event is associated with the first job and the second event is associated with the second job based on the sum of the first score and the fourth score being less than the sum of the second score and the third score, as described above.

As further shown in FIG. 5, process 500 may include modifying the third time period and the fourth time period to generate modified schedule data (block 560). For example, the device may modify the third time period to generate a modified third time period corresponding to a calculated duration of the first job and the fourth time period to generate a modified fourth time period corresponding to a calculated duration of the second job, wherein the third time period is modified based on the first time period and the fourth time period is modified based on the second time period, as described above.

Although FIG. 5 shows example blocks of process 500, in some implementations, process 400 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, vehicle data associated with a plurality of vehicles, wherein, for each vehicle, of the plurality of vehicles, the vehicle data identifies a respective event, a respective location at which the respective event occurred, and a respective event time period corresponding to a duration of the respective event;
receiving, by the device, schedule data associated with a plurality of jobs, wherein, for each job, of the plurality of jobs, the schedule data indicates a respective job location, a respective job time period corresponding to a predicted duration associated with the respective job;
determining, by the device, a set of scores for each job, of the plurality of jobs based on the vehicle data and the schedule data, wherein the set of scores for each job, of the plurality of jobs, indicates a set of likelihoods that each event, of the plurality of events, is associated with each job;
determining, by the device, a set of assignments of events, of the plurality of events, to jobs, of the plurality of jobs based on the set of scores for each job;
determining, by the device, a calculated job time period for each job, of the plurality of jobs based on the set of assignments of events to jobs, wherein a calculated job time period for a job, of the plurality of jobs, is determined based on a duration of an event assigned to the job in the set of assignments of events to jobs;
modifying, by the device and based on the calculated job time period determined for each job, the schedule data generate modified schedule data; and
generating, by the device, new schedule data for a new job based on the modified schedule data, wherein a type of the new job corresponds to a type of a particular job, of the plurality of jobs, and the new schedule data indicates a new job time period for the new job that corresponds to a particular job time period, indicated by the modified schedule data, for the particular job.

2. The method of claim 1, wherein determining the set of scores for each job comprises:
determining that a first event, of the plurality of events, corresponds to an idling event;
determining, based on the first event corresponding to the idling event, a first value based on a sum of an event time period corresponding to a duration of the first event and a job time period corresponding to a predicted duration associated with the first job;
determining a second value based on a distance between a location of the first event and a location of the first job; and
determining a first score, of a set of scores determined for the first job, based on the first value and the second value.

3. The method of claim 1, wherein determining the set of scores for each job comprises:
determining that a first event, of the plurality of events, corresponds to a stop event;
setting, based on the first event corresponding to the stop event, a first event time period corresponding to a duration of the first event to a minimum time period;
determining, based on the first event corresponding to the stop event, a first value based on the first event time period and the minimum time period;
determining a second value based on a distance between a location of the first event and a location a first job, of the plurality of jobs; and
determining, a first score, of the set of scores determined for the first job, based on the first value and the second value.

4. The method of claim 3, wherein the minimum time period is equal to zero seconds.

5. The method of claim 1, wherein determining the set of scores for each job comprises:
generating a first event and a second event based on an event, of the plurality of event, wherein the first event is associated with a location at which the event occurred and a portion of an event time period corresponding to a duration of the event and the second event is associated with the location at which the event occurred and a remaining portion of the event time period corresponding to the duration of the event;
determining a first score, of a set of scores determined for a first job, of the plurality of jobs, based on the location at which the event occurred, a location of the first job, and the portion of the event time period corresponding to the duration of the event, wherein the first score indicates a first likelihood that the first event is associated with the first job; and
determining a second score, of the set of scores determined for the first job, based on the location at which the event occurred, the location of the first job, and the remaining portion of the event time period corresponding to the duration of the event, wherein the second score indicates a second likelihood that the second event is associated with the first job.

6. The method of claim 1, wherein the vehicle data identifies a first event, of the plurality of events, a first location of the first event, a first time period corresponding to a duration of the first event, a second event, of the plurality of events, a second location of the second event, and a second time period corresponding to a duration of the second event; and
wherein determining the respective set of scores for each job comprises:
determining a first score, of a set of scores determined for a first job, of the plurality of jobs, based on a difference between the first location and a location of the first job, a difference between the second location and the location of the first job, the first time period, and the second time period, wherein the first score indicates a likelihood that the first job is associated with the first event and the second event.

7. The method of claim 1, wherein the vehicle data identifies a first event, of the plurality of events, a second event, of the plurality of events, and a third event, of the plurality of events; and
wherein determining the respective set of scores for each job comprises:
determining a first score, of a set of scores determined for a first job, of the plurality of jobs, based on a sum of a first score that indicates a likelihood that the first event is associated with the first job, a second score that indicates a likelihood that the second event is associated with the first job, and a third score, wherein the fifth score is a value associated with the third event not being associated with any job, of the plurality of jobs.

8. A non-transitory computer-readable medium storing a set of instructions, the set of instructions comprising:
one or more instructions that, when executed by one or more processors of a device, cause the device to:
receive vehicle data associated with a plurality of vehicles, wherein, for each vehicle, of the plurality of vehicles, the vehicle data identifies a respective event, a respective location at which the respective event occurred, and a respective event time period corresponding to a duration of the respective event;
receive schedule data associated with a plurality of jobs, wherein, for each job, of the plurality of jobs, the schedule data indicates a respective job location, a respective job time period corresponding to a predicted duration associated with the respective job;
determine a set of scores for each job, of the plurality of jobs based on the vehicle data and the schedule data, wherein the set of scores for each job, of the plurality of jobs, indicates a set of likelihoods that each event, of the plurality of events, is associated with each job;
determine a set of assignments of events, of the plurality of events, to jobs, of the plurality of jobs based on the set of scores for each job;
determine a calculated job time period for each job, of the plurality of jobs based on the set of assignments of events to jobs, wherein a calculated job time period for a job, of the plurality of jobs, is determined based on a duration of an event assigned to the job in the set of assignments of events to jobs;
modify, based on the calculated job time period determined for each job, the schedule data generate modified schedule data; and
generate new schedule data for a new job based on the modified schedule data, wherein a type of the new job corresponds to a type of a particular job, of the plurality of jobs, and the new schedule data indicates a new job time period for the new job that corresponds to a particular job time period, indicated by the modified schedule data, for the particular job.

9. The non-transitory computer-readable medium of claim 8, wherein the one or more instructions, that cause the device to determine the set of scores for each job, cause the device to:
determine that a first event, of the plurality of events, corresponds to an idling event;
determine, based on the first event corresponding to the idling event, a first value based on a sum of an event time period corresponding to a duration of the first event and a job time period corresponding to a predicted duration associated with the first job;
determine a second value based on a distance between a location of the first event and a location of the first job; and
determine a first score, of a set of scores determined for the first job, based on the first value and the second value.

10. The non-transitory computer-readable medium of claim 8, wherein the one or more instructions, that cause the device to determine the set of scores for each job, cause the device to:
determine that a first event, of the plurality of events, corresponds to a stop event;
set, based on the first event corresponding to the stop event, a first event time period corresponding to a duration of the first event to a minimum time period;
determine, based on the first event corresponding to the stop event, a first value based on the first event time period and the minimum time period;
determine a second value based on a distance between a location of the first event and a location of a first job, of the plurality of jobs; and
determine a first score, of the set of scores determined for the first job, based on the first value and the second value.

11. The non-transitory computer-readable medium of claim 10, wherein the minimum time period is equal to zero seconds.

12. The non-transitory computer-readable medium of claim 8, wherein the one or more instructions, that cause the device to determine the set of scores for each job, cause the device to:
generate a first event and a second event based on an event, of the plurality of events, wherein the first event is associated with a location at which the event occurred and a portion of an event time period corresponding to a duration of the event and the second event is associated with the location at which the event occurred and a remaining portion of the event time period corresponding to the duration of the event;
determine a first score, of a set of scores determined for a first job, of the plurality of jobs, based on the location at which the event occurred, a location of the first job, and the portion of the event time period corresponding to the duration of the event, wherein the first score indicates a first likelihood that the first event is associated with the first job; and
determine a second score, of the set of scores determined for the first job, based on the location at which the event occurred, the location of the first job, and the remaining portion of the event time period corresponding to the duration of the event, wherein the second score indicates a second likelihood that the second event is associated with the first job.

13. The non-transitory computer-readable medium of claim 8, wherein the vehicle data identifies a first event, of the plurality of events, a first location of the first event, a first time period corresponding to a duration of the first event, a second event, of the plurality of events, a second location of the second event, and a second time period corresponding to a duration of the second event; and
wherein the one or more instructions, that cause the device to determine the set of scores for each job, cause the device to:
determine a first score, of a set of scores determined for a first job, of the plurality of jobs, based on a difference between the first location and a location of the first job, a difference between the second location and the location of the first job, the first time period, and the second time period, wherein the first score indicates a likelihood that the first job is associated with the first event and the second event.

14. The non-transitory computer-readable medium of claim 8, wherein the vehicle data identifies a first event, of the plurality of events, a second event, of the plurality of events, and a third event, of the plurality of events; and
wherein the one or more instructions, that cause the device to determine the set of scores for each job, cause the device to:
determine a first score, of a set of scores determined for a first job, of the plurality of jobs, based on a sum of a first score that indicates a likelihood that the first event is associated with the first job, a second score that indicates a likelihood that the second event is associated with the first job, and a third score, wherein the third score is a value associated with the third event not being associated with any job, of the plurality of jobs.

15. A device, comprising:
one or more processors configured to:
receive vehicle data associated with a plurality of vehicles, wherein, for each vehicle, of the plurality of vehicles, the vehicle data identifies a respective event, a respective location at which the respective event occurred, and a respective event time period corresponding to a duration of the respective event;
receive schedule data associated with a plurality of jobs, wherein, for each job, of the plurality of jobs, the schedule data indicates a respective job location, a respective job time period corresponding to a predicted duration associated with the respective job;
determine a set of scores for each job, of the plurality of jobs based on the vehicle data and the schedule data, wherein the set of scores for each job, of the plurality of jobs, indicates a set of likelihoods that each event, of the plurality of events, is associated with each job;
determine a set of assignments of events, of the plurality of events, to jobs, of the plurality of jobs based on the set of scores for each job;
determine a calculated job time period for each job, of the plurality of jobs based on the set of assignments of events to jobs, wherein a calculated job time period for a job, of the plurality of jobs, is determined based on a duration of an event assigned to the job in the set of assignments of events to jobs;
modify, based on the calculated job time period determined for each job, the schedule data generate modified schedule data; and
generate new schedule data for a new job based on the modified schedule data, wherein a type of the new job corresponds to a type of a particular job, of the plurality of jobs, and the new schedule data indicates a new job time period for the new job that corresponds to a particular job time period, indicated by the modified schedule data, for the particular job.

16. The device of claim 15, wherein the one or more processors, to determine the set of scores for each job, are configured to:
determine that a first event, of the plurality of events, corresponds to an idling event;
determine, based on the first event corresponding to the idling event, a first value based on a sum of an event time period corresponding to a duration of the first event and a job time period corresponding to a predicted duration associated with the first job;
determine a second value based on a distance between a location of the first event and a location of the first job; and
determine a first score, of a set of scores determined for the first job, based on the first value and the second value.

17. The device of claim 15, wherein the one or more processors, to determine the set of scores for each job, are configured to:
determine that a first event, of the plurality of events, corresponds to a stop event;
set, based on the first event corresponding to the stop event, a first event time period corresponding to a duration of the first event to a minimum time period;
determine, based on the first event corresponding to the stop event, a first value based on the first event time period and the minimum time period;
determine a second value based on a distance between a location of the first event and a location of a first job, of the plurality of jobs; and
determine a first score, of the set of scores determined for the first job, based on the first value and the second value.

18. The device of claim 15, wherein the one or more processors, to determine the set of scores for each job, are configured to:
generate a first event and a second event based on an event, of the plurality of events, wherein the first event is associated with a location at which the event occurred and a portion of an event time period corresponding to a duration of the event and the second event is associated with the location at which the event occurred and a remaining portion of the event time period corresponding to the duration of the event;
determine a first score, of a set of scores determined for a first job, of the plurality of jobs, based on the location at which the event occurred, a location of the first job, and the portion of the event time period corresponding to the duration of the event, wherein the first score indicates a first likelihood that the first event is associated with the first job; and
determine a second score, of the set of scores determined for the first job, based on the location at which the event occurred, the location of the first job, and the remaining portion of the event time period corresponding to the duration of the event, wherein the second score indicates a second likelihood that the second event is associated with the first job.

19. The device of claim 15, wherein the vehicle data identifies a first event, of the plurality of events, a first location of the first event, a first time period corresponding to a duration of the first event, a second event, of the plurality of events, a second location of the second event, and a second time period corresponding to a duration of the second event; and
wherein the one or more processors, to determine the set of scores for each job, are configured to:
determine a first score, of a set of scores determined for a first job, of the plurality of jobs, based on a difference between the first location and a location of the first job, a difference between the second location and the location of the first job, the first time period, and the second time period, wherein the first score indicates a likelihood that the first job is associated with the first event and the second event.

20. The device of claim 15, wherein the vehicle data identifies a first event, of the plurality of events, a second event, of the plurality of events, and a third event, of the plurality of events; and
wherein the one or more processors, to determine the set of scores for each job, are configured to:
determine a first score, of a set of scores determined for a first job, of the plurality of jobs, based on a sum of a first score that indicates a likelihood that the first event is associated with the first job, a second score that indicates a likelihood that the second event is associated with the first job, and a third score, wherein the third score is a value associated with the third event not being associated with any job, of the plurality of jobs.
